(19) United States
(12) Patent Application Publication
(10) Pub. No.: US 2018/0049080 A1
(43) Pub. Date: Feb. 15, 2018

(54) NETWORK CONTROLLED SHARING OF MEASUREMENT GAPS FOR INTRA AND INTER FREQUENCY MEASUREMENTS FOR WIRELESS NETWORKS

(71) Applicant: NOKIA SOLUTIONS AND NETWORKS OY, Espoo (FI)

(72) Inventors: Li ZHANG, Beijing (CN); Ren DA, Warren, NJ (US); Lars DALSGAARD, Oulu (FI)

(21) Appl. No.: 15/234,445

(22) Filed: Aug. 11, 2016

(51) Int. Cl. H04W 36/00; H04W 4/00

(52) U.S. Cl. CPC H04W 36/0088; H04W 36/0072; H04W 4/005

(57) ABSTRACT

A technique includes receiving, by a user device in a wireless network, a measurement gap allocation instruction from a serving cell, the measurement gap allocation instruction indicating a distribution of measurement gaps to be used for measurements on multiple carrier frequencies, including for intra-frequency measurements and inter-frequency measurements, and performing, by the user device, measurements for one or more carrier frequencies during one or more measurement gaps based on the measurement gap allocation instruction.

### TECHNICAL FIELD

This description relates to communications, and in particular, to network controlled sharing of measurement gaps for intra-frequency measurements and inter-frequency measurements for wireless networks.

### BACKGROUND

A communication system may be a facility that enables communication between two or more nodes or devices, such as fixed or mobile communication devices. Signals can be carried on wired or wireless carriers.

An example of a cellular communication system is an architecture that is being standardized by the 3^{rd} Generation Partnership Project (3GPP). A recent development in this field is often referred to as the long-term evolution (LTE) of the Universal Mobile Telecommunications System (UMTS) radio-access technology. S-UTRA (evolved UMTS Terrestrial Radio Access) is the air interface of 3GPP's Long Term Evolution (LTE) upgrade path for mobile networks. In LTE, base stations or access points (APs), which are referred to as enhanced Node AP (eNBs), provide wireless access within a coverage area or cell. In LTE, mobile devices, or mobile stations are referred to as user equipments (UE). LTE has included a number of improvements or developments.

User devices may typically perform cell search and measurement, which may include, for example, a user device searching for, synchronizing to, and estimating the received signal quality from one or more neighbor cells. The received signal quality of the neighboring cells, in relation to a signal quality of a serving cell (currently serving the user device) may then be evaluated to determine if a handover (for a user device in a connected state, or a cell reselection for a user device in an idle state) should be performed for the user device to the neighbor cell. Measurement may include, e.g., the user device tuning its wireless transceiver (transmitter/receiver) to a frequency to receive synchronization signals (e.g., primary synchronization signals and secondary synchronization signals) from a neighbor cell, acquiring frequency and symbol synchronization and frame synchronization to the neighbor cell, determining a physical cell identity or cell ID of the neighbor cell, and measuring a signal quality (e.g., reference signal received power/RSRP) of signals received from the neighbor cell.

### SUMMARY

According to an example implementation, a method may include receiving, by a user device in a wireless network, a measurement gap allocation instruction from a serving cell, the measurement gap allocation instruction indicating a distribution of measurement gaps to be used for measurements on multiple carrier frequencies, including for intra-frequency measurements and inter-frequency measurements, and performing, by the user device, measurements for one or more carrier frequencies during one or more measurement gaps based on the measurement gap allocation instruction.

According to an example implementation, an apparatus includes at least one processor and at least one memory including computer instructions, when executed by the at least one processor, cause the apparatus to: receive, by a user device in a wireless network, a measurement gap allocation instruction from a serving cell, the measurement gap allocation instruction indicating a distribution of measurement gaps to be used for measurements on multiple carrier frequencies, including for intra-frequency measurements and inter-frequency measurements, and perform, by the user device, measurements for one or more carrier frequencies during one or more measurement gaps based on the measurement gap allocation instruction.

According to an example implementation, an apparatus includes means for receiving, by a user device in a wireless network, a measurement gap allocation instruction from a serving cell, the measurement gap allocation instruction indicating a distribution of measurement gaps to be used for measurements on multiple carrier frequencies, including for intra-frequency measurements and inter-frequency measurements, and means for performing, by the user device, measurements for one or more carrier frequencies during one or more measurement gaps based on the measurement gap allocation instruction.

According to an example implementation, a computer program product includes a computer-readable storage medium and storing executable code that, when executed by at least one data processing apparatus, is configured to cause the at least one data processing apparatus to perform a method including: receiving, by a user device in a wireless network, a measurement gap allocation instruction from a serving cell, the measurement gap allocation instruction indicating a distribution of measurement gaps to be used for measurements on multiple carrier frequencies, including for intra-frequency measurements and inter-frequency measurements, and performing, by the user device, measurements for one or more carrier frequencies during one or more measurement gaps based on the measurement gap allocation instruction.

According to an example implementation, a method may include transmitting, by a network device in a wireless network, a measurement gap allocation instruction, the measurement gap allocation instruction indicating a distribution of measurement gaps to be used for measurements on multiple carrier frequencies, including for intra-frequency measurements and inter-frequency measurements.

According to an example implementation, an apparatus includes at least one processor and at least one memory including computer instructions, when executed by the at least one processor, cause the apparatus to: transmit, by a network device in a wireless network, a measurement gap allocation instruction, the measurement gap allocation instruction indicating a distribution of measurement gaps to be used for measurements on multiple carrier frequencies, including for intra-frequency measurements and inter-frequency measurements.

According to an example implementation, an apparatus includes means for transmitting, by a network device in a wireless network, a measurement gap allocation instruction, the measurement gap allocation instruction indicating a distribution of measurement gaps to be used for measurements on multiple carrier frequencies, including for intra-frequency measurements and inter-frequency measurements.

According to an example implementation, a computer program product includes a computer-readable storage medium and storing executable code that, when executed by at least one data processing apparatus, is configured to cause the at least one data processing apparatus to perform a method including: transmitting, by a network device in a wireless network, a measurement gap allocation instruction, the measurement gap allocation instruction indicating a distribution of measurement gaps to be used for measurements on multiple carrier frequencies, including for intra-frequency measurements and inter-frequency measurements.

The details of one or more examples of implementations are set forth in the accompanying drawings and the description below. Other features will be apparent from the description and drawings, and from the claims.

### BRIEF DESCRIPTION OF THE DRAWINGS

FIG. 1 is a block diagram of a wireless network according to an example implementation.

FIG. 2 is a diagram illustrating operation of a user device performing intra-frequency measurement and inter-frequency measurement according to an example implementation.

FIG. 3 is a diagram illustrating operation of a system according to an example implementation.

FIG. 4 is a flow chart illustrating operation of a user device according to an example implementation.

FIG. 5 is a flow chart illustrating operation of a network device according to an example implementation.

FIG. 6 is a block diagram of a node or wireless station (e.g., network device, base station/access point or mobile station/user device/UE) according to an example implementation.

### DETAILED DESCRIPTION

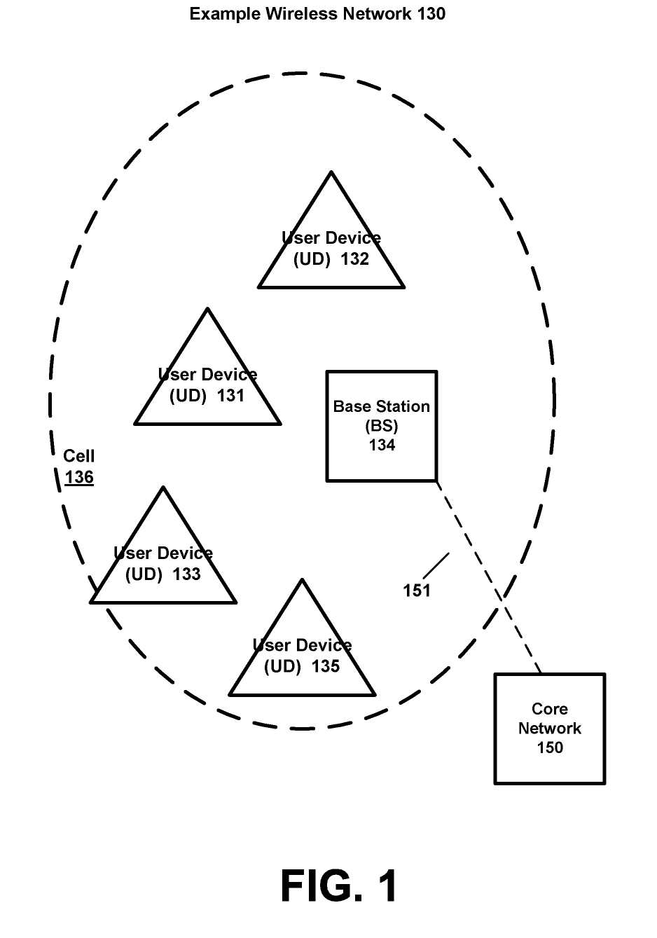

FIG. 1 is a block diagram of a wireless network 130 according to an example implementation. In the wireless network 130 of FIG. 1, user devices 131, 132, 133 and 135, which may also be referred to as mobile stations (MSs) or user equipment (UEs), may be connected (and in communication) with a base station (BS) 134, which may also be referred to as an access point (AP), an enhanced Node B (eNB) or a network node. At least part of the functionalities of an access point (AP), base station (BS) or (e) Node B (eNB) may be also be carried out by any node, server or host which may be operably coupled to a transceiver, such as a remote radio head. BS (or AP) 134 provides wireless coverage within a cell 136, including to user devices 131, 132, 133 and 135. Although only four user devices are shown as being connected or attached to BS 134, any number of user devices may be provided. BS 134 is also connected to a core network 150 via a S1 interface 151. This is merely one simple example of a wireless network, and others may be used.

A user device (user terminal, user equipment (UE)) may refer to a portable computing device that includes wireless mobile communication devices operating with or without a subscriber identification module (SIM), including, but not limited to, the following types of devices: a mobile station (MS), a mobile phone, a cell phone, a smartphone, a personal digital assistant (PDA), a handset, a device using a wireless modem (alarm or measurement device, etc.), a laptop and/or touch screen computer, a tablet, a phablet, a game console, a notebook, and a multimedia device, as examples. It should be appreciated that a user device may also be a nearly exclusive uplink only device, of which an example is a camera or video camera loading images or video clips to a network.

By way of illustrative example, the various example implementations or techniques described herein may be applied to various user devices, such as machine type communication (MTC) user devices, enhanced machine type communication (eMTC) user devices, Internet of Things (IoT) user devices, and/or narrowband IoT user devices. IoT may refer to an ever-growing group of objects that may have Internet or network connectivity, so that these objects may send information to and receive information from other network devices. For example, many sensor type applications or devices may monitor a physical condition or a status, and may send a report to a server or other network device, e.g., when an event occurs.

Machine Type Communications (MTC, or Machine to Machine communications) may, for example, be characterized by fully automatic data generation, exchange, processing and actuation among intelligent machines, with or without intervention of humans. For example, eMTC may be an example of a narrowband user device, where the eMTC or narrowband user device is limited to transmission or reception within a narrowband (e.g., a subset, such as only a few or small number physical resource blocks/PRBs as compared to a larger system or cell bandwidth). By limiting the operation of an eMTC user device to a narrowband (or limited bandwidth or partial bandwidth, as compared to a system or cell bandwidth), this may allow cheaper or less expensive eMTC user devices to be used for specific MTC applications or uses. IoT and/or narrowband IoT devices may also include operation within a narrowband.

The narrowband bandwidth (e.g., a small number of PRBs, such as 6 PRBs, or other number) of an eMTC user device may be smaller/narrower than a system bandwidth of an LTE cell, which may have a bandwidth of, for example, 100 PRBs (or other number of PRBs). A PRB (physical resource block) may, for example, include a first number of subcarriers by a second number of orthogonal frequency division multiplex (OFDM) symbols. In an example implementation, a PRB may be 12 subcarriers by 7 OFDM symbols, although this is merely an illustrative example, and other numbers may be used. As noted, by limiting the transmission/reception bandwidth to a narrowband (narrower than a cell system bandwidth), this may reduce the cost of eMTC and/or narrowband IoT devices. While some of the example user devices have been described that operate within a narrowband, such as eMTC or IoT or narrowband IoT user devices, these are merely examples and the various example implementations are not limited thereto.

In LTE (as an example), core network 150 may be referred to as Evolved Packet Core (EPC), which may include a mobility management entity (MME) which may handle or assist with mobility/handover of user devices between BSs, one or more gateways that may forward data and control signals between the BSs and packet data networks or the Internet, and other control functions or blocks.

The various example implementations may be applied to a wide variety of wireless technologies or wireless networks, such as LTE, LTE-A, 5G, cmWave, and/or mmWave band networks, IoT, MTC, eMTC, etc., or any other wireless network or wireless technology. These example networks or technologies are provided only as illustrative examples, and the various example implementations may be applied to any wireless technology/wireless network. Also, as noted, the various example implementations may be applied to a variety of user devices, such as, for example, user devices, UEs, mobile stations, eMTC user devices, and/or IoT or narrowband IoT user devices.

According to an example implementation, a measurement gap may be a time period (e.g., 6 ms or 6 subframes according to an illustrative example) during which a user device does not transmit data or signals. Rather, during this measurement gap, the user device may perform measurement, wherein the user device may, for example, tune its wireless receiver (transmitter/receiver) to a carrier frequency to receive synchronization signals (e.g., primary synchronization signals and secondary synchronization signals) from a neighbor cell. Based on these synchronization signals, the user device (or UE) may acquire (or determine) frequency synchronization, and symbol and frame synchronization (or timing) to the neighbor cell, determine a physical cell identity or cell ID of the neighbor cell, and then measure a signal quality or signal power (e.g., reference signal received power (RSRP)) of signals received from the neighbor cell. The measurement gap may typically provide time to allow the user device to switch frequencies (e.g., tune to the new carrier frequency to be measured), receive synchronization signals, acquire synchronization, and measure RSRP of signals from one or more neighbor cells, for example.

In some cases, a user device may receive and measure signals from a plurality of cells during the measurement gap. After measuring a power (e.g., RSRP) of one or more neighbor cells, the UE may send a measurement report to its serving cell to report the received power for each of the one or more neighbor cells. In an example implementation, if the received power of the signal received from a neighbor cell is greater than the signal power of a signal received from the serving cell by more than a threshold, for example, then the serving cell may make a decision to perform a handover for the user device to the neighbor cell.

According to an example implementation, intra-frequency measurement may include a user device performing measurement on signals received from one or more neighbor cells at a downlink carrier frequency that is the same as a downlink carrier frequency of a serving cell for the user device. And, inter-frequency measurement may include a user device performing measurement on signals received from one or more neighbor cells at a downlink carrier frequency that is different from a downlink carrier frequency of a serving cell for the user device.

In an example implementation, a cell may use different PRBs within its system bandwidth for transmitting and receiving data (via operating PRBs) and sending synchronization signals (via center PRBs, which may be centered on a downlink carrier frequency). In an illustrative example, a cell may transmit synchronization signals via a set of 6 (or other number) center PRBs that are centered on the carrier frequency. On the other hand, a working set of 6 (or other number) PRBs may be allocated for transmitting and/or receiving data to a user device, and are typically offset from the carrier frequency. For example, different center PRBs may be allocated or scheduled for different user devices that are connected to a cell, whereas all user devices may receive a cell's synchronization signals via the center PRBs.

According to an example implementation, for a full bandwidth (or wideband) user device, e.g., where the bandwidth of the user device is the same (or nearly the same) as the system bandwidth of the serving cell and/or cells to be measured, then the user device may perform intra-frequency measurement of one or more neighbor cells while, at the same time, receiving signals or data from the serving cell on the same carrier frequency. This is because a full bandwidth user device can simultaneously receive: 1) a working set of PRBs from the serving cell (e.g., to receive downlink data from the serving cell), while receiving 2) a center set of PRBs (e.g., to receive synchronization signals from a neighbor cell that is transmitting on the same carrier frequency as the serving cell). Thus, a full bandwidth user device may perform intra-frequency measurement without necessarily using (or needing) the measurement gaps to perform intra-frequency measurement.

However, a full bandwidth user device will typically need to perform inter-frequency measurement (of neighbor cells) during the measurement gap(s), because the (single receiver) user device typically cannot receive signals simultaneously on two different carrier frequencies (e.g., carrier 1 from the serving cell and carrier 2 from the cell to be measured). In addition, time is required for the user device to switch carrier frequencies on its wireless receiver, e.g., from carrier 1 of the serving cell to carrier 2 of the neighbor cell.

For a narrowband (or partial bandwidth) user device (e.g., narrowband IoT device or eMTC user device), the narrowband user device is capable of transmitting or receiving only on or within a subset of PRBs that are part of the system bandwidth of a cell. Thus, according to an example implementation, a narrowband user device (e.g., eMTC user device or other narrowband or partial bandwidth device) may have a bandwidth of, for example, 6 PRBs (or other subset of PRBs that is less than the total number of PRBs of a cell's system bandwidth), which is less than a system bandwidth (e.g., 100 PRBs) of a cell.

According to an example implementation, a narrowband (or partial bandwidth) user device may use a measurement gap(s) to perform both intra-frequency measurement and inter-frequency measurement. Inter-frequency measurement for a narrowband user device operates similar to inter-frequency measurement for a full bandwidth user device (e.g., legacy LTE user device or UE), where the user device would switch frequencies from carrier 1 (transmitted by the serving cell) to carrier 2 (transmitted by one or more cells to be measured), and then receiving synchronization signals, and measuring RSRP of received signals. However, intra-frequency measurement for a narrowband (or partial bandwidth) user device is slightly different than for a full bandwidth user device, because the narrowband user device may typically need to tune its receiver frequency to switch between operating PRBs for a serving cell and a set of center PRBs for a neighbor cell to be measured. Thus, switching between these PRBs (or subcarrier frequencies) takes time, which is provided during a measurement gap.

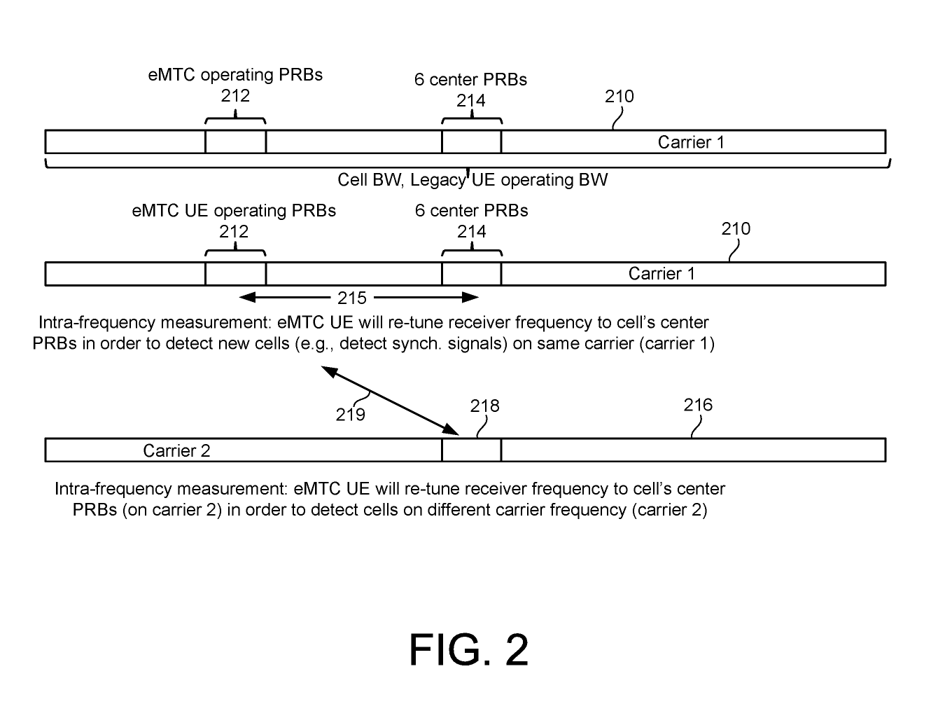

FIG. 2 is a diagram illustrating operation of a user device, such as a narrowband user device, performing intra-frequency measurement and inter-frequency measurement according to an example implementation. A system bandwidth 210 at carrier frequency 1 (or carrier 1) for a cell is shown (e.g., for the serving cell). The system bandwidth 210 may be a cell bandwidth (or system bandwidth) for one or more cells transmitting via carrier frequency 1 (carrier 1), for example. System bandwidth 210 may also be the bandwidth of a full bandwidth (e.g., legacy UE) user device, e.g., which may be 100 or more PRBs, for example. The system bandwidth 210 for carrier 1 includes many PRBs, including 6 center PRBs 214 over which a cell will transmit synchronization signals (and possibly other signals), and a set of 6 eMTC operating PRBs 212. The set of 6 operating PRBs 212 for an eMTC (or other narrowband user device) may be the PRBs over which an eMTC user device may transmit or receive data, and these operating PRBs may change over time, as scheduled by the serving cell/BS.

As shown by line 215 in FIG. 2, a narrowband (or partial bandwidth) user device may perform intra-frequency measurement during a measurement gap by retuning its receiver frequency from the operating PRBs 212 to the set of center PRBs 214 for carrier 1. Once tuned to the center PRBs 214 of carrier 1, the user device may then receive the synchronization signals, e.g., from a neighbor cell, to allow the user device to perform measurement of the neighbor cell (e.g., including acquiring synchronization, obtaining the cell ID for the neighbor cell, and measuring received signal power from the neighbor cell).

As shown by line 219 in FIG. 2, a narrowband (or partial bandwidth) user device may perform inter-frequency measurement during a measurement gap by retuning its receiver frequency from the operating PRBs 212 of carrier 1 to a set of center PRBs 218 for carrier 2. The system bandwidth 216 is shown in FIG. 2 for carrier frequency 2 (or carrier 2). Once tuned to the center PRBs 218 of carrier 2, the user device may then receive the synchronization signals, e.g., from a neighbor cell, to allow the user device to perform measurement of the neighbor cell (e.g., including acquiring synchronization, obtaining the cell ID for the neighbor cell, and measuring received signal power from the neighbor cell).

Thus, it can be seen from FIG. 2 that for a narrowband user device (for example), the narrowband user device may only be able to receive or transmit a subset of PRBs that is less than the cell (or system) bandwidth. Thus, according to this illustrative example, an example narrowband user device may, for example, be able to receive either a set of operating PRBs (e.g., to receive data from a serving cell) or receive a set of center PRBs (e.g., to perform measurement based on received synchronization signals), but not both at the same time.

According to an example implementation, a measurement gap may be 6 ms (or 6 subframes) in length, and may have a period of 40-80 ms. These are merely example numbers, and other length measurement gaps and measurement gap periods may be used.

As noted, the narrowband (or partial bandwidth or limited bandwidth) user device may switch its receiver frequency at the beginning of a measurement gap (e.g., switch from operating PRBs 212 of carrier 1 of a serving cell) to center PRBs 214 of carrier 1 (for intra-frequency measurement) or to center PRBs 218 of carrier 2 (for inter-frequency measurement). For example, after receiving synchronization signals, acquiring symbol and frame synchronization, obtaining a cell ID, and/or measuring received signal power from a cell, the user device may, within the same carrier, repeat these operations (by way of illustrative example) for one or more other cells (receiving synchronization signals from the cell, acquiring synchronization, obtaining cell ID, and/or measuring signal power). According to this illustrative example, at (or near) the end of the measurement gap, the narrowband user device may then tune or switch its receiver frequency back to the operating PRBs 212 of carrier 1 to resume operation (e.g., to resume transmitting or receiving signals with its serving cell).

According to an example implementation, a network (e.g., core network, a BS, or other network entity) may control a distribution or allocation of measurement gaps for a narrowband (or partial bandwidth) user device for measurements of multiple carrier frequencies, wherein the multiple carrier frequencies may include both an intra-frequency carrier from one or more cells, and inter-frequency carriers from one or more cells. Several different techniques or approaches may be used to control a distribution or allocation of measurement gaps for a narrowband (or partial bandwidth) user device. Also, measurement gaps may be distributed to different carrier groups or categories.

According to an example implementation, a flexible measurement gap sharing (or gap distribution) may be provided between intra-frequency carriers and inter-frequency carriers, and/or among already (previously) configured carriers and newly configured carriers.

According to an example implementation, the allocation or distribution of measurement gaps may be controlled or directed by a network, e.g., based on the network (or a network entity, such as core network entity or a BS) sending, e.g., from or via a serving cell, a measurement gap allocation instruction to the user device. According to an example implementation, the measurement gap allocation instruction may instruct the user device, e.g., the narrowband (or partial bandwidth) user device, to allocate use of measurement gaps for measurement among different categories or groups of carriers, according to one of several different gap sharing rules or approaches. The user device would then use the measurement gaps to perform intra-frequency measurement and inter-frequency measurement according to (or based on) the measurement gap allocation instruction.

In an example implementation, the measurement gap allocation instruction may be communicated from a serving BS to a user device as part of a measurement configuration parameter(s), which may be provided within a Radio Resource Control (RRC) Connection Reconfiguration message. Thus, in an example implementation, the RRC Connection Reconfiguration Message may include a list of carrier frequencies (e.g., listed by carrier number) to be measured by the user device, and a measurement gap allocation instruction that allocates or distributes measurement gaps for measuring a plurality of carriers (carrier frequencies).

According to an example implementation, by specifying the distribution of measurement gaps via a measurement gap allocation instruction, the network or network entity may be able to direct user device(s) to one or more carrier frequencies (or to cells transmitting such carrier frequencies) or categories of carrier frequencies by instructing the user device to perform (via a measurement gap allocation instruction) measurement of such category (or categories) of carrier frequencies. In this manner, it may be more likely that the user device will perform a handover to a cell transmitting on such measured carrier frequency (or to such measured category or categories of carriers), as indicated by the measurement gap allocation instruction. In this manner, the network or network entity may, for example, perform load balancing of user devices connected to different cells, e.g., by performing load balancing between 1) previously identified (or previously configured) carrier frequencies and newly identified (or newly configured) carrier frequencies, or 2) between intra-frequency carriers and inter-frequency carriers, or other type of load balancing between two or more categories or types of carriers/carrier frequencies, based on the measurement gap allocation instruction. For example, the network may use the measurement gap allocation instruction to shift or move one or more user devices to a different carrier frequency (or to a different cell or group of cells) than the serving carrier (e.g., by specifying a large percentage of measurement gaps for inter-frequency measurement), or to a newly configured carrier(s) (which may be carriers that are newly indicated for measurement in the RRC Connection Reconfiguration message), etc.

Several example gap sharing rules may include the following, by way of illustrative example:

1) According to a first example gap sharing rule or approach, measurement gaps may be distributed (or allocated) between intra-frequency carriers and inter-frequency carriers. In this example, a different amount of measurement gaps may be allocated for intra-frequency measurement as compared to inter-frequency measurements. For example, the network may assign or allocate a first amount (e.g., x number or x%) of the measurement gaps to be used to measure intra-frequency carriers; and assign or allocate a second amount, e.g., the remaining number or a remaining percentage (100−x)% of measurement gaps to be used to measure inter-frequency carriers. For example, the remaining number or percentage (e.g., 100−x%) may be allocated to (and may be evenly distributed among) all inter-frequency carriers that are listed or identified (e.g., by a RRC Connection Reconfiguration message) by the network to the user device for measurement.

There are a number of different techniques that may be used to indicate a distribution of measurement gaps for intra-frequency measurement and for inter-frequency measurement. Thus, by way of illustrative example, the measurement gap allocation instruction may include a first amount (e.g., indicating a first number or first percentage of measurement gaps) to be used for intra-frequency measurements, and a second amount (e.g., indicating a second number or second percentage) of measurement gaps to be used for inter-frequency measurements. For example, the measurement gap allocation instruction may indicate that 50% of the measurement gaps should be used for intra-frequency measurements, and 50% of the measurement gaps should be used for inter-frequency measurements. Or, as another example, in order to make it more likely that a user device will perform a handover to a cell transmitting on a different carrier frequency than the serving cell (inter-frequency), the measurement gap allocation instruction may indicate to a user device that 10% of the measurement gaps be used to measure intra-frequency carriers, and 90% of the measurement gaps be used to measure inter-frequency carriers. For example, with a greater number of inter-frequency measurements, this will make it more likely that a received power of a signal that is a sufficient RSRP to cause a handover will be an inter-frequency carrier (e.g., because more time will be spent performing inter-frequency measurement).

Although some of the illustrative examples above may include both a first amount of measurement gaps indicated for intra-frequency measurement and a second amount indicated for inter-frequency measurement, the measurement gap allocation instruction may, for example, only indicate an amount of measurement gaps to be used for either intra-frequency or inter-frequency measurement. In such case, the user device may determine the second amount based on the first amount. For example, if the measurement gap allocation instruction indicates that 30% of measurement gaps to be used for inter-frequency measurement, then the user device can determine that 100-30%=70% of the measurement gaps are to be used for intra-frequency measurements, even though 70% may not be explicitly provided within the control signal or measurement gap allocation instruction, according to this illustrative example. In this manner, a measurement gap allocation instruction may indicate a distribution of measurement gaps to be used for two (or more) different categories of carriers, even though an amount (e.g., number or percentage) of measurement gaps may be indicated for one (or less than all) of the categories.

2) According to a second gap sharing rule or approach, measurement gaps may be distributed or allocated between previously configured carriers (including previously configured intra frequency carriers and previously inter-frequency carriers) and new (or newly) configured inter-frequency carriers. Previously configured carriers may be carriers that were previously indicated or identified for measurement, e.g., within a previously received RRC Connection Reconfiguration message or within a previously received measurement gap allocation instruction. Newly configured carriers are carriers configured for measurement that are identified in a new or current RRC Connection Reconfiguration message or within a new or current measurement gap allocation instruction. Different amounts (e.g., different numbers or different percentages) of measurement gaps may be allocated to previously configured carriers and newly configured inter-frequency carriers. For example, the network may allocate x% of the measurement gaps to measure existing or previously configured carriers, including both (existing or previously configured) intra-frequency and inter-frequency carriers. In an example implementation, the x% gaps can be evenly distributed to or among all existing carriers; the remaining (100−x)% may be distributed (e.g., evenly distributed) to or among all new (all newly configured) inter-frequency carriers. In this manner, the network may, for example, facilitate or cause user devices to measure more (or less) of the newly configured carrier frequencies (and measure less (or more) existing, or previously configured or previously measured carrier frequencies), e.g., if previous measurements by the user device did not identify an adequate cell for handover.

3) According to a third gap sharing rule or approach, measurement gaps may be distributed or allocated to: intra-frequency carriers, existing (previously configured) inter-frequency carriers and new (or newly configured) inter-frequency carriers. For example, the network may allocate or assign x% of measurement gaps to intra-frequency carrier, y% of measurement gaps to existing inter-frequency carriers; while the remaining (100−x−y)% of the measurement gaps may be allocated to (e.g., evenly distributed among all) new inter-frequency carriers. Thus, in such an illustrative example, the measurement gap allocation instruction may indicates: a first amount of measurement gaps to be used to perform measurement for intra-frequency carriers; a second amount of measurement gaps to be used to perform measurement for previously configured inter-frequency carriers that were configured for measurement in a previous gap allocation instruction; and a third amount of measurement gaps to be used to perform measurement for newly identified inter-frequency carriers that are newly configured for measurement in the gap allocation instruction. The term amount may include a number or a percentage, for example, or other value.

4) According to a fourth gap sharing rule or approach, measurement gaps may be distributed or allocated to each carrier frequency identified indicated for measurement. For example, the measurement gap allocation instruction includes: an identification of one or more carrier frequencies for which measurement should be performed; and an indication, for one or more of the identified carrier frequencies, of an amount (e.g., number or percentage) of measurement gaps to be used for performing measurement for the carrier frequency.

According to an example implementation, the network may send signaling (e.g., measurement gap allocation instruction) to start, or adjust the gap share (measurement gap distribution) assignment or allocation for the groups or categories of carriers, or to stop or terminate the group or category gap share, and/or to reactivate the gap share/gap distribution. In an example implementation, if a gap share or measurement gap distribution is stopped or terminated by control signal from the network or serving BS, then a default gap measurement distribution may apply, e.g., measurement gaps are evenly shared by intra-frequency and inter-frequency carriers. Other default measurement gap distributions may be used, e.g., which may be used when the gap share or gap distribution has been terminated by the network. In addition, or in the alternative, the network may also control the time period during which the configured gap split (or gap distribution) would apply, while after that measurement by user device may be based on a default gap split or default measurement gap distribution (e.g., all intra-frequency and inter-frequency carrier will have the same share or percentage of gaps).

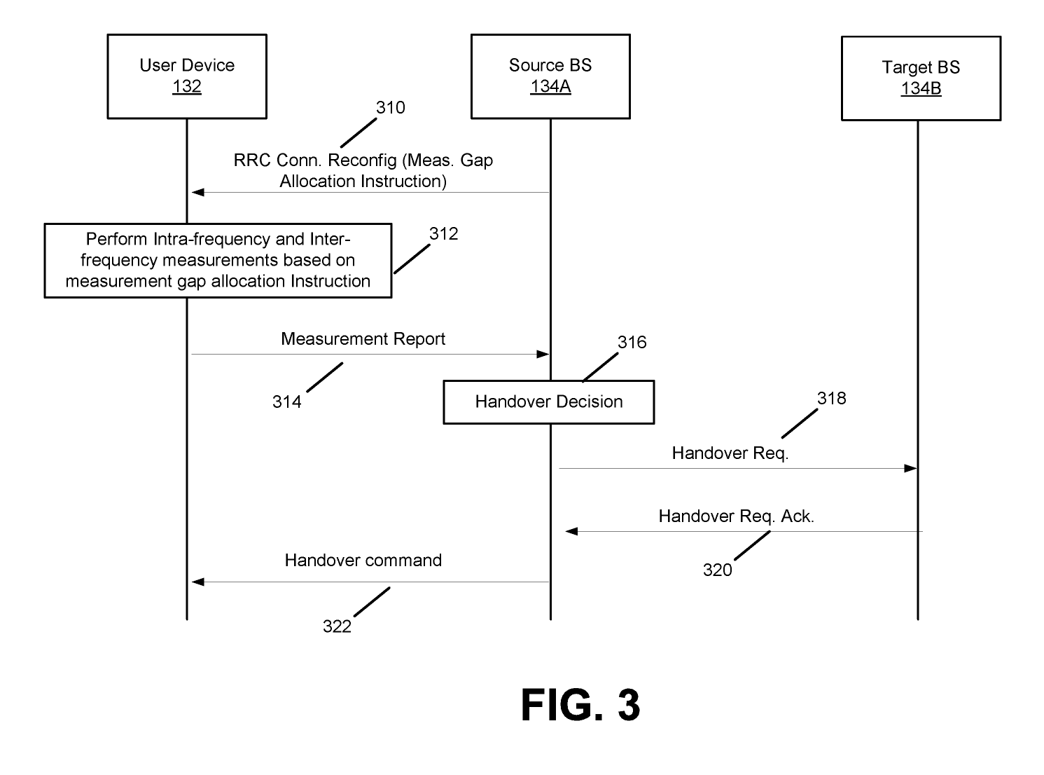

FIG. 3 is a diagram illustrating operation of a system according to an example implementation. A user device 132 may be in communication with a serving (or source) BS 134A (serving cell) and a target BS 134B (target cell). At 310, the user device 132 receives a RRC Connection Reconfiguration message from the serving (or source) BS 134A. The RRC Connection Reconfiguration message may include a measurement gap allocation instruction. At 312, the user device performs measurements on a plurality of carriers based on the measurement gap allocation instruction. Performing a measurement may include, for example, performing one or more of the following based on received signals from a cell: receiving synchronization signals from a neighbor cell, and acquiring one or more of: frequency synchronization, symbol synchronization, frame synchronization to the neighbor cell, and identifying or determining a cell identifier (cell ID) for the neighbor cell; and measuring a signal quality or signal power (e.g., RSRP) of a signal(s) received from the neighbor cell.

At 314, the user device 132 may transmit a measurement report to the source BS 134A, where the measurement report may include a cell ID and a power or RSRP for each cell ID, e.g., for each cell (or one or more of the cells) that is measured. At 316, the source (or serving) BS 134A may make or determine a handover decision, e.g., determine to handover the user device 132 to target BS 134B based on the measurement report. At 318, the source BS 134 may send a handover request (requesting handover of the user device) to target BS 134B. At 320, the source BS 134A receives a handover request acknowledgement that acknowledges or confirms handover of the user device 132. At 322, the source BS 134A sends a handover command to the user device 132. Thereafter, the user device 132 may communicate with the target BS (target cell).

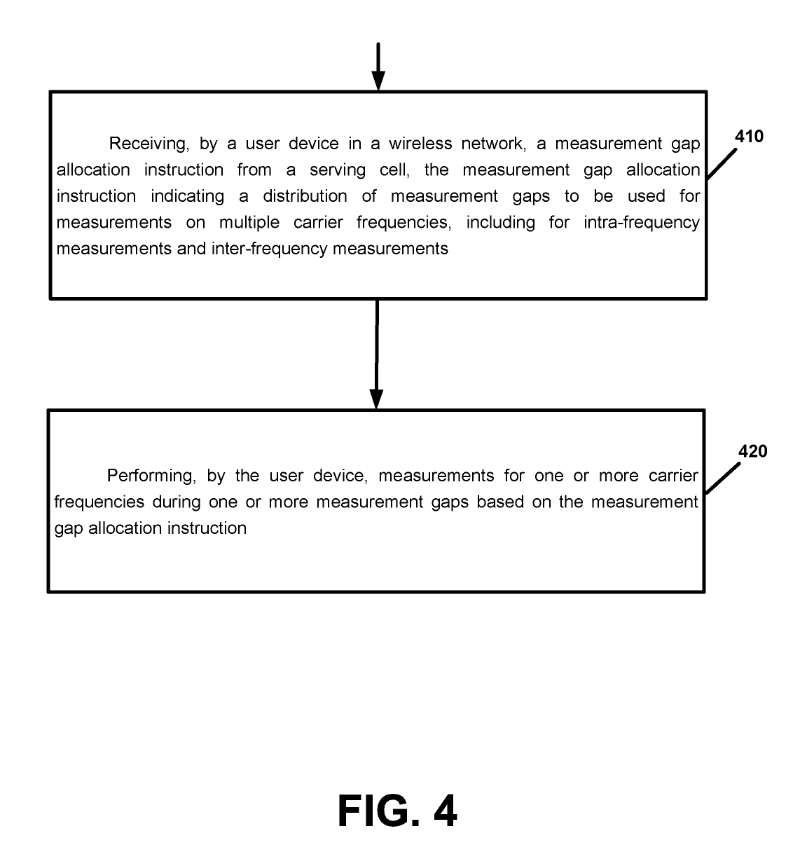

FIG. 4 is a flow chart illustrating operation of a user device according to an example implementation. Operation 410 includes receiving, by a user device in a wireless network, a measurement gap allocation instruction from a serving cell, the measurement gap allocation instruction indicating a distribution of measurement gaps to be used for measurements on multiple carrier frequencies, including for intra-frequency measurements and inter-frequency measurements. Operation 420 includes performing, by the user device, measurements for one or more carrier frequencies during one or more measurement gaps based on the measurement gap allocation instruction.

According to an example implementation of the method of FIG. 4, the receiving may include: receiving, by a user device in a wireless network, a measurement gap allocation instruction from a serving cell, the measurement gap allocation instruction indicating at least one of a first amount of measurement gaps to be used for intra-frequency measurements and a second amount of measurement gaps to be used for inter-frequency measurements.

According to an example implementation of the method of FIG. 4, the first amount may include a first number or percentage of measurement gaps to be used for intra-frequency measurements; and the second amount may include a second number or percentage of measurement gaps to be used for inter-frequency measurements.

According to an example implementation of the method of FIG. 4, the receiving may include receiving, by a user device in a wireless network, a measurement gap allocation instruction from a serving cell, the measurement gap allocation instruction indicating at least a first amount of measurement gaps to be used for a first category of carriers, wherein one or more other amounts of measurement gaps to be used to measure one or more other categories of carriers may be determined by the user device based on at least the first amount.

According to an example implementation of the method of FIG. 4, the receiving may include receiving, by a user device in a wireless network, a measurement gap allocation instruction from a serving cell, the measurement gap allocation instruction indicating a first amount of measurement gaps to be used for either intra-frequency measurements or inter-frequency measurements, wherein a second amount of measurement gaps to be used for either inter-frequency measurements or intra-frequency measurements, which is not specified by the first amount, may be determined based on the first amount.

According to an example implementation of the method of FIG. 4, the measurement gap allocation instruction indicates: a first amount of measurement gaps to be used to perform measurement for previously configured intra-frequency carriers and inter-frequency carriers, where the previously configured carriers were configured for measurement in a previous measurement gap allocation instruction; and a second amount of measurement gaps to be used to perform measurement for newly configured inter-frequency carriers that are newly configured for measurement in the gap allocation instruction.

According to an example implementation of the method of FIG. 4, the measurement gap allocation instruction includes an identification of one or more carrier frequencies for which measurement should be performed; and an indication, for one or more of the identified carrier frequencies, of an amount of measurement gaps to be used for performing measurement for the carrier frequency. The amount may include either a number or a percentage, for example.

According to an example implementation of the method of FIG. 4, the measurement gap allocation instruction indicates a first amount of measurement gaps to be used to perform measurement for intra-frequency carriers; a second amount of measurement gaps to be used to perform measurement for previously configured inter-frequency carriers that were configured for measurement in a previous gap allocation instruction; and a third amount of measurement gaps to be used to perform measurement for newly identified inter-frequency carriers that are newly configured for measurement in the gap allocation instruction.

According to an example implementation of the method of FIG. 4, the measurement may include at least one of the following: receiving synchronization signals from a neighbor cell, and acquiring one or more of: frequency synchronization, symbol synchronization, frame synchronization to the neighbor cell, and identification of a cell identifier (cell ID) for the neighbor cell; and measuring a signal quality or signal power of a signal(s) received from the neighbor cell.

According to an example implementation of the method of FIG. 4, the user device may include a partial bandwidth user device that is capable of receiving or transmitting signals only within a subset of physical resource blocks (PRBs) that are part of (and less than) a serving cell's system bandwidth. For example, the user device may be an enhanced machine type communications (eMTC) user device

According to an example implementation of the method of FIG. 4, the user device may include an enhanced machine type communications (eMTC) user device that can only transmit or receive signals within a narrowband or subset of the serving cell's bandwidth that includes only a subset of contiguous physical resource blocks (PRBs).

According to an example implementation of the method of FIG. 4, the measurement gap allocation instruction is provided within a measurement configuration parameter, which is received by the user device from the serving cell within a RRC (Radio Resource Control) Connection Reconfiguration message.

According to an example implementation of the method of FIG. 4: intra-frequency measurement may include performing measurement on signals received from one or more neighbor cells at a downlink carrier frequency that is the same as a downlink carrier frequency of a serving cell for the user device; and inter-frequency measurement may include performing measurement on signals received from one or more neighbor cells at a downlink carrier frequency that is different from a downlink carrier frequency of a serving cell for the user device.

According to an example implementation of the method of FIG. 4, the method may further include determining, by the user device, that a distribution of measurement of gaps is not in effect; and performing, by the user device in response to determining that a distribution of measurement gaps is not in effect for the user device, measurements for one or more carrier frequencies during one or more measurement gaps in accordance with a default measurement gap distribution.

According to an example implementation of the method of FIG. 4, the measurement gap allocation instruction includes a first measurement gap allocation instruction indicating a first distribution of measurement gaps, the method further including: receiving, by the user device, a second measurement gap allocation instruction from a serving cell, the measurement gap allocation instruction indicating a second distribution of measurement gaps; discontinuing the default measurement gap distribution in response to receiving the second measurement gap allocation instruction; and performing, by the user device, measurements for one or more carrier frequencies during one or more measurement gaps based on the second distribution of measurement gaps indicated by the second measurement gap allocation instruction.

According to an example implementation of the method of FIG. 4, the distribution of measurement of gaps indicated by the measurement gap allocation instruction is a default measurement gap distribution, the method further including: discontinuing the default measurement gap distribution; and reactivating, by the user device, the default measurement gap distribution in response to a detected condition. According to an example implementation, the reactivating may include reactivating, by the user device, the default measurement gap distribution in response to at least one of the following conditions: the user device detecting certain measurement results; the user device receiving a control signal requesting the user device to reactivate or resume the default measurement gap distribution; based on a timer expiring, or reactivating the default measurement gap distribution at a specific time or a specified time; and a periodic reactivation, by the user device, of the default measurement gap distribution.

According to an example implementation of the method of FIG. 4, the determining that a distribution of measurement of gaps is not in effect may include performing at least one of the following: determining that a measurement gap distribution, indicated via the measurement gap allocation instruction, has expired; and receiving, by the user device from the serving base station, a gap sharing termination instruction that instructs the user device to stop or terminate a sharing or distribution of measurement gaps among a plurality of carriers.

According to an example implementation of the method of FIG. 4, the performing measurements in accordance with the default measurement gap distribution may include: performing, by the user device, measurements for one or more carrier frequencies, wherein measurement gaps are shared equally among all carrier frequencies, including intra-frequency carrier frequencies and inter-frequency carrier frequencies, on which the user device is performing measurement.

According to an example implementation of the method of FIG. 4, the measurement gap allocation instruction indicates a time period for which the distribution of measurement gaps shall be in effect for, the method further including: determining, by the user device based on the time period in the measurement gap allocation instruction, that the distribution of measurement gaps has expired or is no longer in effect; and performing, by the user device, measurements for one or more carrier frequencies during one or more measurement gaps in accordance with a default measurement gap distribution.

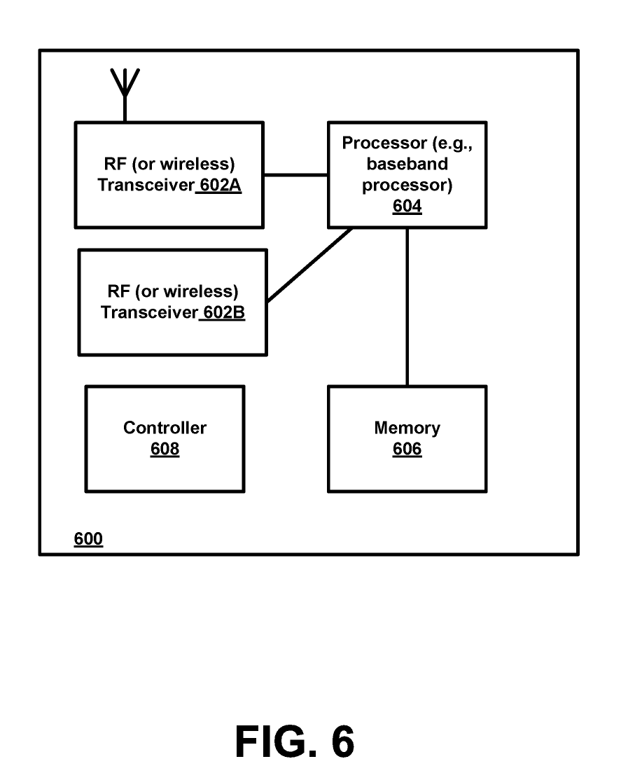

An apparatus may include means (e.g., 602A/602B and/or 604, FIG. 6) for receiving, by a user device in a wireless network, a measurement gap allocation instruction from a serving cell, the measurement gap allocation instruction indicating a distribution of measurement gaps to be used for measurements on multiple carrier frequencies, including for intra-frequency measurements and inter-frequency measurements, and means (e.g., 602A/602B and/or 604, FIG. 6) for performing, by the user device, measurements for one or more carrier frequencies during one or more measurement gaps based on the measurement gap allocation instruction.

According to an example implementation of the apparatus, the means for receiving may include: means (e.g., 602A/602B and/or 604, FIG. 6) for receiving, by a user device in a wireless network, a measurement gap allocation instruction from a serving cell, the measurement gap allocation instruction indicating a first amount of measurement gaps to be used for intra-frequency measurements and a second amount of measurement gaps to be used for inter-frequency measurements.

According to an example implementation of the apparatus, the first amount may include a first number or percentage of measurement gaps to be used for intra-frequency measurements; and the second amount may include a second number or percentage of measurement gaps to be used for inter-frequency measurements.

According to an example implementation of the apparatus, the means for receiving may include means (e.g., 602A/602B and/or 604, FIG. 6) for receiving, by a user device in a wireless network, a measurement gap allocation instruction from a serving cell, the measurement gap allocation instruction indicating at least a first amount of measurement gaps to be used for a first category of carriers, wherein one or more other amounts of measurement gaps to be used to measure one or more other categories of carriers may be determined by the user device based on at least the first amount.

According to an example implementation of the apparatus, the means for receiving may include means (e.g., 602A/602B and/or 604, FIG. 6) for receiving, by a user device in a wireless network, a measurement gap allocation instruction from a serving cell, the measurement gap allocation instruction indicating a first amount of measurement gaps to be used for either intra-frequency measurements or inter-frequency measurements, wherein a second amount of measurement gaps to be used for either inter-frequency measurements or intra-frequency measurements, which is not specified by the first amount, may be determined based on the first amount.

According to an example implementation of the apparatus, the measurement gap allocation instruction indicates: a first amount of measurement gaps to be used to perform measurement for previously configured intra-frequency carriers and inter-frequency carriers, where the previously configured carriers were configured for measurement in a previous measurement gap allocation instruction; and a second amount of measurement gaps to be used to perform measurement for newly configured inter-frequency carriers that are newly configured for measurement in the gap allocation instruction.

According to an example implementation of the apparatus, the measurement gap allocation instruction includes an identification of one or more carrier frequencies for which measurement should be performed; and an indication, for one or more of the identified carrier frequencies, of an amount of measurement gaps to be used for performing measurement for the carrier frequency. The amount may include either a number or a percentage, for example.

According to an example implementation of the apparatus, the measurement gap allocation instruction indicates a first amount of measurement gaps to be used to perform measurement for intra-frequency carriers; a second amount of measurement gaps to be used to perform measurement for previously configured inter-frequency carriers that were configured for measurement in a previous gap allocation instruction; and a third amount of measurement gaps to be used to perform measurement for newly identified inter-frequency carriers that are newly configured for measurement in the gap allocation instruction.

According to an example implementation of the apparatus, a means for performing a measurement may include at least one of the following: means (e.g., 602A/602B and/or 604, FIG. 6) for receiving synchronization signals from a neighbor cell, and means (e.g., 602A/602B and/or 604, FIG. 6) for acquiring one or more of: frequency synchronization, symbol synchronization, frame synchronization to the neighbor cell, and identification of a cell identifier (cell ID) for the neighbor cell; and means (e.g., 602A/602B and/or 604, FIG. 6) for measuring a signal quality or signal power of a signal(s) received from the neighbor cell.

According to an example implementation of the apparatus, the user device may include a partial bandwidth user device that is capable of receiving or transmitting signals only within a subset of physical resource blocks (PRBs) that are part of (and less than) a serving cell's system bandwidth. For example, the user device may be an enhanced machine type communications (eMTC) user device

According to an example implementation of the apparatus, the user device may include an enhanced machine type communications (eMTC) user device that can only transmit or receive signals within a narrowband or subset of the serving cell's bandwidth that includes only a subset of contiguous physical resource blocks (PRBs).

According to an example implementation of the apparatus, the measurement gap allocation instruction is provided within a measurement configuration parameter, which is received by the user device from the serving cell within a RRC (Radio Resource Control) Connection Reconfiguration message.

According to an example implementation of the apparatus: intra-frequency measurement may include performing measurement on signals received from one or more neighbor cells at a downlink carrier frequency that is the same as a downlink carrier frequency of a serving cell for the user device; and inter-frequency measurement may include performing measurement on signals received from one or more neighbor cells at a downlink carrier frequency that is different from a downlink carrier frequency of a serving cell for the user device.

According to an example implementation of the apparatus, the apparatus may further include means (e.g., 602A/602B and/or 604, FIG. 6) for determining, by the user device, that a distribution of measurement of gaps is not in effect; and performing, by the user device in response to determining that a distribution of measurement gaps is not in effect for the user device, measurements for one or more carrier frequencies during one or more measurement gaps in accordance with a default measurement gap distribution.

According to an example implementation of the apparatus, the means for determining that a distribution of measurement of gaps is not in effect may include at least one of the following: means (e.g., 602A/602B and/or 604, FIG. 6) for determining that a measurement gap distribution, indicated via the measurement gap allocation instruction, has expired; and means (e.g., 602A/602B and/or 604, FIG. 6) for receiving, by the user device from the serving base station, a gap sharing termination instruction that instructs the user device to stop or terminate a sharing or distribution of measurement gaps among a plurality of carriers.

According to an example implementation of the apparatus, the means for performing measurements in accordance with the default measurement gap distribution may include: means (e.g., 602A/602B and/or 604, FIG. 6) for performing, by the user device, measurements for one or more carrier frequencies, wherein measurement gaps are shared equally among all carrier frequencies, including intra-frequency carrier frequencies and inter-frequency carrier frequencies, on which the user device is performing measurement.

According to an example implementation of the apparatus, the measurement gap allocation instruction indicates a time period for which the distribution of measurement gaps shall be in effect for, the method further including: determining, by the user device based on the time period in the measurement gap allocation instruction, that the distribution of measurement gaps has expired or is no longer in effect; and performing, by the user device, measurements for one or more carrier frequencies during one or more measurement gaps in accordance with a default measurement gap distribution.

An apparatus includes at least one processor and at least one memory including computer instructions, when executed by the at least one processor, cause the apparatus to: receive, by a user device in a wireless network, a measurement gap allocation instruction from a serving cell, the measurement gap allocation instruction indicating a distribution of measurement gaps to be used for measurements on multiple carrier frequencies, including for intra-frequency measurements and inter-frequency measurements; and perform, by the user device, measurements for one or more carrier frequencies during one or more measurement gaps based on the measurement gap allocation instruction.

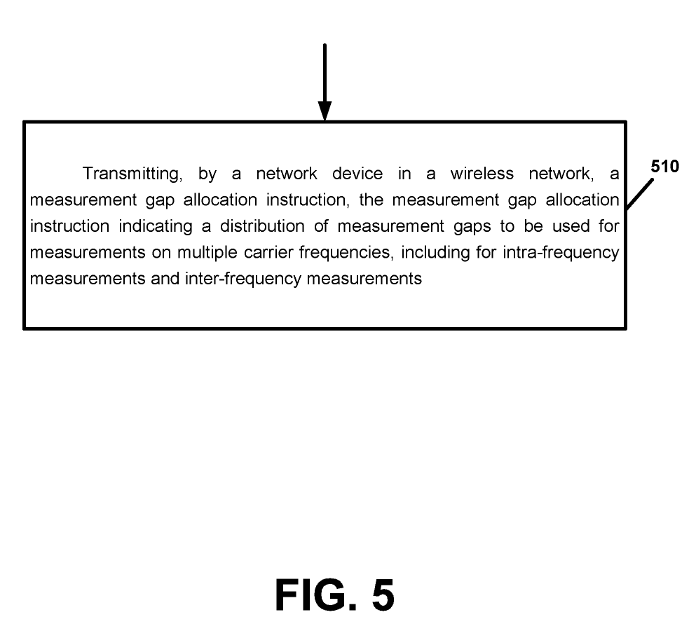

FIG. 5 is a flow chart illustrating operation of a network device according to an example implementation. Operation 510 includes transmitting, by a network device in a wireless network, a measurement gap allocation instruction, the measurement gap allocation instruction indicating a distribution of measurement gaps to be used for measurements on multiple carrier frequencies, including for intra-frequency measurements and inter-frequency measurements.

According to an example implementation of the method of FIG. 5, the method may further include performing, by the network device, a handover of a user device to a neighbor cell based on a measurement, by the user device, of carrier frequencies based on the measurement gap allocation instruction.

According to an example implementation of the method of FIG. 5, the transmitting may include: transmitting a measurement gap allocation instruction, the measurement gap allocation instruction indicating at least one of a first amount of measurement gaps to be used for intra-frequency measurements and a second amount of measurement gaps to be used for inter-frequency measurements.

According to an example implementation of the method of FIG. 5: the first amount may include a first number or percentage of measurement gaps to be used for intra-frequency measurements; and the second amount may include a second number or percentage of measurement gaps to be used for inter-frequency measurements.

According to an example implementation of the method of FIG. 5, the transmitting may include: transmitting a measurement gap allocation instruction from a serving cell, the measurement gap allocation instruction indicating a first amount of measurement gaps to be used for either intra-frequency measurements or inter-frequency measurements, wherein a second amount of measurement gaps to be used for either inter-frequency measurements or intra-frequency measurements, which is not specified by the first amount, may be determined based on the first amount.

According to an example implementation of the method of FIG. 5, the measurement gap allocation instruction indicates: a first amount of measurement gaps to be used to perform measurement for previously configured intra-frequency carriers and inter-frequency carriers, where the previously configured carriers were configured for measurement in a previous measurement gap allocation instruction; and a second amount of measurement gaps to be used to perform measurement for newly configured inter-frequency carriers that are newly configured for measurement in the gap allocation instruction.

According to an example implementation of the method of FIG. 5, the measurement gap allocation instruction may include: an identification of one or more carrier frequencies for which measurement should be performed; and an indication, for one or more of the identified carrier frequencies, of an amount of measurement gaps to be used for performing measurement for the carrier frequency.

According to an example implementation of the method of FIG. 5, the measurement gap allocation instruction indicates: a first amount of measurement gaps to be used to perform measurement for intra-frequency carriers; a second amount of measurement gaps to be used to perform measurement for previously configured inter-frequency carriers that were configured for measurement in a previous gap allocation instruction; and a third amount of measurement gaps to be used to perform measurement for newly identified inter-frequency carriers that are newly configured for measurement in the gap allocation instruction.

According to an example implementation of the method of FIG. 5, the transmitting may include: transmitting, by a network device in a wireless network, a measurement gap allocation instruction, from a serving cell, the measurement gap allocation instruction indicating a first amount of measurement gaps to be used for either intra-frequency measurements or inter-frequency measurements, wherein a second amount of measurement gaps to be used for either inter-frequency measurements or intra-frequency measurements, which is not specified by the first amount, may be determined based on the first amount.

According to an example implementation of the method of FIG. 5, the method may further include transmitting, by the network device, a gap sharing termination instruction that instructs a user device to stop or terminate a sharing or distribution of measurement gaps among a plurality of carriers.

According to an example implementation of the method of FIG. 5, the measurement gap allocation instruction indicates a time period for which the distribution of measurement gaps shall be in effect for, wherein a default measurement gap distribution is to be used when the distribution of measurement gaps is not in effect.

According to an example implementation, an apparatus includes at least one processor and at least one memory including computer instructions, when executed by the at least one processor, cause the apparatus to: transmit, by a network device in a wireless network, a measurement gap allocation instruction, the measurement gap allocation instruction indicating a distribution of measurement gaps to be used for measurements on multiple carrier frequencies, including for intra-frequency measurements and inter-frequency measurements.

According to an example implementation, an apparatus includes means (e.g., 602A/602B and/or 604, FIG. 6) for transmitting, by a network device in a wireless network, a measurement gap allocation instruction, the measurement gap allocation instruction indicating a distribution of measurement gaps to be used for measurements on multiple carrier frequencies, including for intra-frequency measurements and inter-frequency measurements.

FIG. 6 is a block diagram of a wireless station (e.g., AP or user device) 600 according to an example implementation. The wireless station 600 may include, for example, one or two RF (radio frequency) or wireless transceivers 602A, 602B, where each wireless transceiver includes a transmitter to transmit signals and a receiver to receive signals. The wireless station also includes a processor or control unit/entity (controller) 604 to execute instructions or software and control transmission and receptions of signals, and a memory 606 to store data and/or instructions.

Processor 604 may also make decisions or determinations, generate frames, packets or messages for transmission, decode received frames or messages for further processing, and other tasks or functions described herein. Processor 604, which may be a baseband processor, for example, may generate messages, packets, frames or other signals for transmission via wireless transceiver 602 (602A or 602B). Processor 604 may control transmission of signals or messages over a wireless network, and may control the reception of signals or messages, etc., via a wireless network (e.g., after being down-converted by wireless transceiver 602, for example). Processor 604 may be programmable and capable of executing software or other instructions stored in memory or on other computer media to perform the various tasks and functions described above, such as one or more of the tasks or methods described above. Processor 604 may be (or may include), for example, hardware, programmable logic, a programmable processor that executes software or firmware, and/or any combination of these. Using other terminology, processor 604 and transceiver 602 together may be considered as a wireless transmitter/receiver system, for example.

In addition, referring to FIG. 6, a controller (or processor) 608 may execute software and instructions, and may provide overall control for the station 600, and may provide control for other systems not shown in FIG. 6, such as controlling input/output devices (e.g., display, keypad), and/or may execute software for one or more applications that may be provided on wireless station 600, such as, for example, an email program, audio/video applications, a word processor, a Voice over IP application, or other application or software.

In addition, a storage medium may be provided that includes stored instructions, which when executed by a controller or processor may result in the processor 604, or other controller or processor, performing one or more of the functions or tasks described above.

According to another example implementation, RF or wireless transceiver(s) 602A/602B may receive signals or data and/or transmit or send signals or data. Processor 604 (and possibly transceivers 602A/602B) may control the RF or wireless transceiver 602A or 602B to receive, send, broadcast or transmit signals or data.

The embodiments are not, however, restricted to the system that is given as an example, but a person skilled in the art may apply the solution to other communication systems. Another example of a suitable communications system is the 5G concept. It is assumed that network architecture in 5G will be quite similar to that of the LTE-advanced. 5G is likely to use multiple input-multiple output (MIMO) antennas, many more base stations or nodes than the LTE (a so-called small cell concept), including macro sites operating in co-operation with smaller stations and perhaps also employing a variety of radio technologies for better coverage and enhanced data rates.

It should be appreciated that future networks will most probably utilise network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations may be carried out, at least partly, in a server, host or node operationally coupled to a remote radio head. It is also possible that node operations will be distributed among a plurality of servers, nodes or hosts. It should also be understood that the distribution of labour between core network operations and base station operations may differ from that of the LTE or even be non-existent.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers. Implementations may also be provided on a computer readable medium or computer readable storage medium, which may be a non-transitory medium. Implementations of the various techniques may also include implementations provided via transitory signals or media, and/or programs and/or software implementations that are downloadable via the Internet or other network(s), either wired networks and/or wireless networks. In addition, implementations may be provided via machine type communications (MTC), and also via an Internet of Things (IOT).

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers.

Furthermore, implementations of the various techniques described herein may use a cyber-physical system (CPS) (a system of collaborating computational elements controlling physical entities). CPS may enable the implementation and exploitation of massive amounts of interconnected ICT devices (sensors, actuators, processors microcontrollers, . . . ) embedded in physical objects at different locations. Mobile cyber physical systems, in which the physical system in question has inherent mobility, are a subcategory of cyber-physical systems. Examples of mobile physical systems include mobile robotics and electronics transported by humans or animals. The rise in popularity of smartphones has increased interest in the area of mobile cyber-physical systems. Therefore, various implementations of techniques described herein may be provided via one or more of these technologies.

A computer program, such as the computer program(s) described above, can be written in any form of programming language, including compiled or interpreted languages, and can be deployed in any form, including as a stand-alone program or as a module, component, subroutine, or other unit or part of it suitable for use in a computing environment. A computer program can be deployed to be executed on one computer or on multiple computers at one site or distributed across multiple sites and interconnected by a communication network.

Method steps may be performed by one or more programmable processors executing a computer program or computer program portions to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer, chip or chipset. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, implementations may be implemented on a computer having a display device, e.g., a cathode ray tube (CRT) or liquid crystal display (LCD) monitor, for displaying information to the user and a user interface, such as a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

What is claimed is:

1. A method comprising:
receiving, by a user device in a wireless network, a measurement gap allocation instruction from a serving cell, the measurement gap allocation instruction indicating a distribution of measurement gaps to be used for measurements on multiple carrier frequencies, including for intra-frequency measurements and inter-frequency measurements; and
performing, by the user device, measurements for one or more carrier frequencies during one or more measurement gaps based on the measurement gap allocation instruction.

2. The method of claim 1 wherein the receiving comprises:
receiving, by a user device in a wireless network, a measurement gap allocation instruction from a serving cell, the measurement gap allocation instruction indicating at least one of a first amount of measurement gaps to be used for intra-frequency measurements and a second amount of measurement gaps to be used for inter-frequency measurements.

3. The method of claim 2 wherein:
the first amount comprises a first number or percentage of measurement gaps to be used for intra-frequency measurements; and
the second amount comprises a second number or percentage of measurement gaps to be used for inter-frequency measurements.

4. The method of claim 1 wherein the receiving comprises:
receiving, by a user device in a wireless network, a measurement gap allocation instruction from a serving cell, the measurement gap allocation instruction indicating at least a first amount of measurement gaps to be used for a first category of carriers, wherein one or more other amounts of measurement gaps to be used to measure one or more other categories of carriers may be determined by the user device based on at least the first amount.

5. The method of claim 1 wherein the receiving comprises:
receiving, by a user device in a wireless network, a measurement gap allocation instruction from a serving cell, the measurement gap allocation instruction indicating a first amount of measurement gaps to be used for either intra-frequency measurements or inter-frequency measurements, wherein a second amount of measurement gaps to be used for either inter-frequency measurements or intra-frequency measurements, which is not specified by the first amount, may be determined based on the first amount.

6. The method of claim 1 wherein the measurement gap allocation instruction indicates:
a first amount of measurement gaps to be used to perform measurement for previously configured intra-frequency carriers and inter-frequency carriers, where the previously configured carriers were configured for measurement in a previous measurement gap allocation instruction; and
a second amount of measurement gaps to be used to perform measurement for newly configured inter-frequency carriers that are newly configured for measurement in the gap allocation instruction.

7. The method of claim 1 wherein the measurement gap allocation instruction comprises:
an identification of one or more carrier frequencies for which measurement should be performed; and
an indication, for one or more of the identified carrier frequencies, of an amount of measurement gaps to be used for performing measurement for the carrier frequency.

8. The method of claim 1 wherein the measurement gap allocation instruction indicates:
a first amount of measurement gaps to be used to perform measurement for intra-frequency carriers;
a second amount of measurement gaps to be used to perform measurement for previously configured inter-frequency carriers that were configured for measurement in a previous gap allocation instruction; and
a third amount of measurement gaps to be used to perform measurement for newly identified inter-frequency carriers that are newly configured for measurement in the gap allocation instruction.

9. The method of claim 1 wherein the user device comprises a partial bandwidth user device that is capable of receiving or transmitting signals only within a subset of physical resource blocks (PRBs) that are part of a serving cell's system bandwidth.

10. The method of claim 1 wherein the user device comprises an enhanced machine type communications (eMTC) user device that can only transmit or receive signals within a narrowband or subset of the serving cell's bandwidth that includes only a subset of contiguous physical resource blocks (PRBs).

11. The method of claim 1 wherein the measurement gap allocation instruction is provided within a measurement configuration parameter, which is received by the user device from the serving cell within a RRC (Radio Resource Control) Connection Reconfiguration message.

12. The method of claim 1 and further comprising:
determining, by the user device, that a distribution of measurement of gaps is not in effect; and
performing, by the user device in response to determining that a distribution of measurement gaps is not in effect for the user device, measurements for one or more carrier frequencies during one or more measurement gaps in accordance with a default measurement gap distribution.

13. The method of claim 1 wherein the distribution of measurement of gaps indicated by the measurement gap allocation instruction is a default measurement gap distribution, the method further comprising:
discontinuing the default measurement gap distribution; and
reactivating, by the user device, the default measurement gap distribution in response to a detected condition.

14. The method of claim 13 wherein reactivating comprises reactivating, by the user device, the default measurement gap distribution in response to at least one of the following conditions:
the user device detecting certain measurement results;
the user device receiving a control signal requesting the user device to reactivate or resume the default measurement gap distribution;
based on a timer expiring, or reactivating the default measurement gap distribution at a specific time or a specified time;
a periodic reactivation, by the user device, of the default measurement gap distribution.

15. The method of claim 12 wherein the determining that a distribution of measurement of gaps is not in effect comprises performing at least one of the following:
determining that a measurement gap distribution, indicated via the measurement gap allocation instruction, has expired; and
receiving, by the user device from the serving base station, a gap sharing termination instruction that instructs the user device to stop or terminate a sharing or distribution of measurement gaps among a plurality of carriers.

16. The method of claim 12 wherein the performing measurements in accordance with the default measurement gap distribution comprises at least one of the following:
performing, by the user device, measurements for one or more carrier frequencies, wherein measurement gaps are shared equally among all carrier frequencies, including intra-frequency carrier frequencies and inter-frequency carrier frequencies, on which the user device is performing measurement.

17. The method of claim 1 wherein the measurement gap allocation instruction indicates a time period for which the distribution of measurement gaps shall be in effect for, the method further comprising:
determining, by the user device based on the time period in the measurement gap allocation instruction, that the distribution of measurement gaps has expired or is no longer in effect; and
performing, by the user device, measurements for one or more carrier frequencies during one or more measurement gaps in accordance with a default measurement gap distribution.

18. An apparatus comprising at least one processor and at least one memory including computer instructions, when executed by the at least one processor, cause the apparatus to:
receive, by a user device in a wireless network, a measurement gap allocation instruction from a serving cell, the measurement gap allocation instruction indicating a distribution of measurement gaps to be used for measurements on multiple carrier frequencies, including for intra-frequency measurements and inter-frequency measurements; and
perform, by the user device, measurements for one or more carrier frequencies during one or more measurement gaps based on the measurement gap allocation instruction.

19. A method comprising:
transmitting, by a network device in a wireless network, a measurement gap allocation instruction, the measurement gap allocation instruction indicating a distribution of measurement gaps to be used for measurements on multiple carrier frequencies, including for intra-frequency measurements and inter-frequency measurements.

20. The method of claim 19 wherein the transmitting comprises:
transmitting a measurement gap allocation instruction, the measurement gap allocation instruction indicating at least one of a first amount of measurement gaps to be used for intra-frequency measurements and a second amount of measurement gaps to be used for inter-frequency measurements.

21. The method of claim 19 wherein:
the first amount comprises a first number or percentage of measurement gaps to be used for intra-frequency measurements; and
the second amount comprises a second number or percentage of measurement gaps to be used for inter-frequency measurements.

22. The method of claim 19 wherein the transmitting comprises:
transmitting a measurement gap allocation instruction from a serving cell, the measurement gap allocation instruction indicating a first amount of measurement gaps to be used for either intra-frequency measurements or inter-frequency measurements, wherein a second amount of measurement gaps to be used for either inter-frequency measurements or intra-frequency measurements, which is not specified by the first amount, may be determined based on the first amount.

23. The method of claim 19 wherein the measurement gap allocation instruction indicates:
a first amount of measurement gaps to be used to perform measurement for previously configured intra-frequency carriers and inter-frequency carriers, where the previously configured carriers were configured for measurement in a previous measurement gap allocation instruction; and
a second amount of measurement gaps to be used to perform measurement for newly configured inter-frequency carriers that are newly configured for measurement in the gap allocation instruction.

24. The method of claim 19 wherein the measurement gap allocation instruction comprises:
an identification of one or more carrier frequencies for which measurement should be performed; and
an indication, for one or more of the identified carrier frequencies, of an amount of measurement gaps to be used for performing measurement for the carrier frequency.

25. The method of claim 19 wherein the measurement gap allocation instruction indicates:
a first amount of measurement gaps to be used to perform measurement for intra-frequency carriers;
a second amount of measurement gaps to be used to perform measurement for previously configured inter-frequency carriers that were configured for measurement in a previous gap allocation instruction; and
a third amount of measurement gaps to be used to perform measurement for newly identified inter-frequency carriers that are newly configured for measurement in the gap allocation instruction.

26. The method of claim 19 wherein the transmitting comprises:
transmitting, by a network device in a wireless network, a measurement gap allocation instruction, from a serving cell, the measurement gap allocation instruction indicating a first amount of measurement gaps to be used for either intra-frequency measurements or inter-frequency measurements, wherein a second amount of measurement gaps to be used for either inter-frequency measurements or intra-frequency measurements, which is not specified by the first amount, may be determined based on the first amount.

27. The method of claim 19 and further comprising:
transmitting, by the network device, a gap sharing termination instruction that instructs a user device to stop or terminate a sharing or distribution of measurement gaps among a plurality of carriers.

28. The method of claim 19 wherein the measurement gap allocation instruction indicates a time period for which the distribution of measurement gaps shall be in effect for, wherein a default measurement gap distribution is to be used when the distribution of measurement gaps is not in effect.
